(19) United States
(12) Patent Application Publication
(10) Pub. No.: US 2006/0024993 A1
(43) Pub. Date: Feb. 2, 2006

(54) High current pin and socket power connector

(76) Inventor: Francisco Gonzalez, San Diego, CA (US)

Correspondence Address: PETER F WEINBERG;GIBSON DUNN AND CRUTCHER LLP, SUITE 4100, 1801 CALIFORNIA STREET, DENVER, CO, 80202, US

(21) Appl. No.: 10/903,229

(22) Filed: Jul. 29, 2004

(51) Int. Cl. H01R 12/00

(52) U.S. Cl. 439/79

(57) ABSTRACT

A pin and socket for high current applications enables a printed circuit board to be directly connected to an electrical device. The socket has a unique bottom part designed to be mounted to a printed circuit board. The bottom part of the socket is forced into a hole in the PCB that has a smaller diameter than the bottom part. A solder ring is placed over the bottom part and seated against the PCB. The solder is melted forming a very secure pressure and solder connection. The pin has a male torsional louver type band around a stem that fits within a bore in the socket. The tail end of the pin has a bore which can threaded for screwing onto the terminals of an electrical device. The tail end can be modified to also provide panel mounting, flying wire mounting, or PCB mounting.

### FIELD OF THE INVENTION

This invention relates to high current power connectors, and more particularly, to a high current pin and socket power connector for applications involving a printed circuit board requiring direct power connection to an electrical device.

### BACKGROUND OF THE INVENTION

Certain electrical applications require a high current connection, defined here to range between ten to sixty amps, between a printed circuit board (“PCB”) and an electrical device, such as a circuit breaker. Prior art solutions for high current applications have typically relied upon FASTON™ terminals which are hard to match up to the receptacle and hard to push on, especially when two, three, or more connections are grouped together and must be simultaneously engaged.

However, FASTON™ terminals have not been successfully adapted for direct soldering to a printed circuit board. Other types of high current connectors are designed to connect from panel to panel or wire to wire, but not from a printed circuit board direct to an electrical device. The types of connectors that are readily available for soldering directly to a printed circuit board, such as through hole connectors (card edge, headers, terminal blocks), surface mount connectors (card edge, headers, terminal blocks), PCB edge connectors, PCB backplane connectors, press fit connector systems, and straddle connector systems, are typically only capable of carrying current of less than ten amps. Thus, there is a need in the art for a high current power connection that can be directly soldered onto a printed circuit board that can carry current from between ten to sixty amps and offers ease of connection direct to an electrical device.

### BRIEF DESCRIPTION OF THE DRAWINGS

FIGS. 1A-1D show various views of the socket for high current applications in an embodiment of the present invention.

FIGS. 2A-2F show various views of the pin for high current applications in an embodiment of the present invention.

FIGS. 3A-3B show a perspective front view and a perspective back view of a printed circuit board having sockets attached thereto for high current applications in an embodiment of the present invention.

FIG. 4 shows a perspective view of a circuit breaker having pins for high current applications attached thereto in an embodiment of the present invention.

FIGS. 5A-5B show two perspective views of a pair of circuit breakers having pins being coupled to a printed circuit board having sockets for high current applications in an embodiment of the present invention.

### DETAILED DESCRIPTION OF THE INVENTION

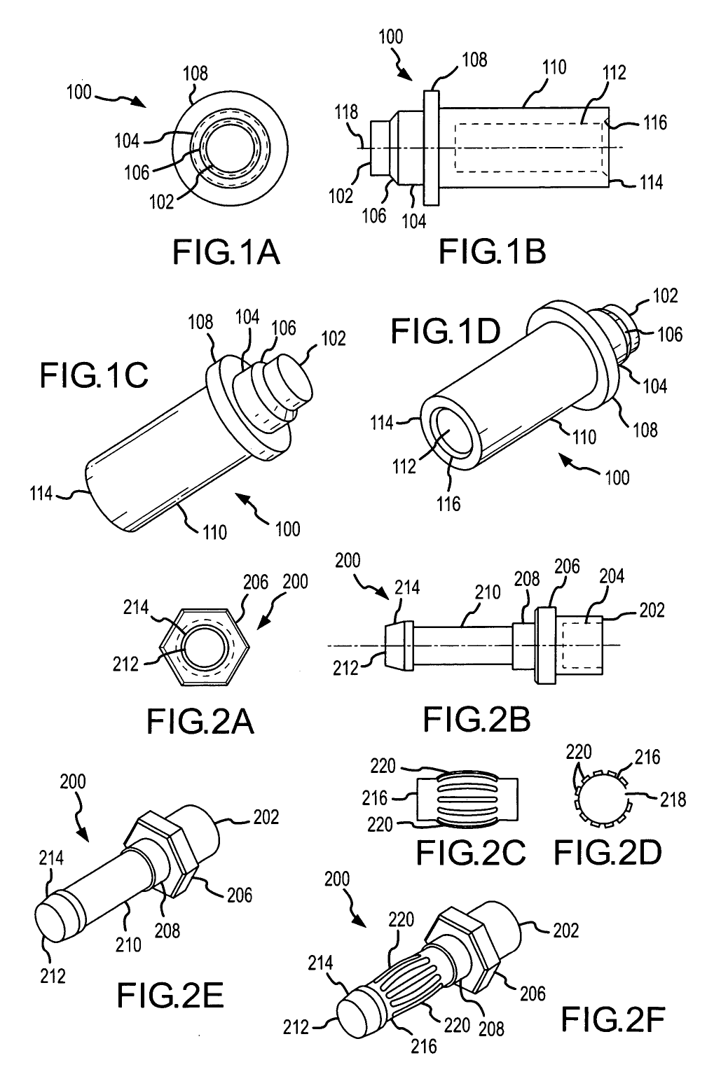

Referring now to the Figures, in which like reference numerals refer to structurally and/or functionally similar elements thereof, FIGS. 1A-1D show various views of the socket for high current applications in an embodiment of the present invention. Referring now to FIGS. 1A-1D, FIG. 1A shows an end view and FIG. 1B shows a plan view of Socket 100. FIG. 1C shows a perspective tail view and FIG. 1D shows a perspective head view of Socket 100. Socket 100 is cylindrical in shape. Tail End 102 has a first diameter, and Enlarged Portion 104 has a slightly larger diameter. Chamfer 106 transitions between Tail End 102 and Enlarged Portion 104. Seating Ring 108 has a larger diameter than Enlarged Portion 104. Tail End 102, Enlarged Portion 104, Chamfer 106, and Seating Ring 108 form a unique bottom part that is designed to be mounted to a PCB.

Shank 110 has a smaller diameter than Seating Ring 108 and has, nearly through its entire length, Bore 112 for receiving Pin 200 (see FIG. 2). Head End 114 has an Interior Chamfer 116 which aids when Pin 200 is inserted therein. Socket 100 will accept a mating Pin 200, or male terminal, that is designed to be inserted into Bore 112.

FIGS. 2A-2F show various views of the pin for high current applications in an embodiment of the present invention. Referring now to FIGS. 2A-2F, FIG. 2A shows an end view and FIG. 2B shows a plan view of Pin 200. FIG. 2C shows a plan view and FIG. 2D shows an end view of Band 216. FIG. 2E shows a perspective head view of Pin 200 before Band 216 is mounted, and FIG. 2F shows a perspective head view of Pin 200 after Band 216 is mounted. Tail End 202 has a first diameter, and has, nearly through its entire length, Bore 204 for attaching to an electrical device, such as a circuit breaker. In one embodiment, Bore 204 has internal threads for screwing onto a threaded terminal of the electrical device. Tail End 202 can be modified in order to provide panel mounting, flying wire mounting, or PCB mounting for termination. Pin 200 can be made of different metal alloys, depending upon the application.

Attached to Tail End 202 is Nut Portion 206, which aids when Pin 200 is screwed onto a threaded terminal of the electrical device. Attached to Nut Portion 206 is Stem Base 208, Stem 210, and Stem Head End 212. Stem 210 has a smaller diameter than Stem Base 208 and Stem Head End 212. Stem Head End 212 has Chamfer 214, which aids when Pin 200 is inserted into Socket 100.

Pin 200 has an external accessory, Band 216, that provides a better electrical interface between itself, Pin 200, and Socket 100. Band 216 is flexible and is spread open along Opening 218 and mounted over Stem 210, between Stem Base 208 and Stem Head End 212. When Band 216 resumes its natural shape, it is secured to Stem 210 through compressive forces. In one embodiment of the invention, Band 216 is a male torsional louver type band. Band 216 has Torsion Members 220, which are spring-like, and gives Band 216 a diameter that is greater than Stem Base 208 and greater than the inside diameter of Bore 112 of Socket 100. Torsion Members 220 engage with the inside diameter of Bore 112 of Socket 100 and compress due to their spring-like nature. This allows for a high current transfer between Socket 100 and Pin 200 with more tolerance between both mating parts. The length of Band 216 is slightly less than the length of Stem 210 because Band 216 increases in length when Torsion Members 220 are compressed.

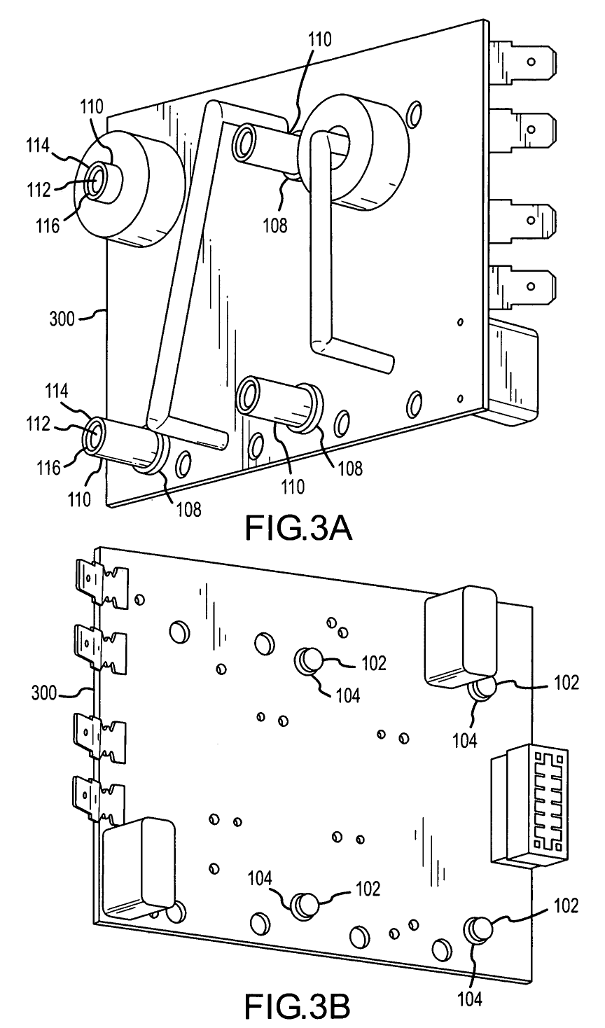

FIGS. 3A-3B show a perspective front view and a perspective back view of a printed circuit board having sockets attached thereto for high current applications in an embodiment of the present invention. Referring now to FIGS. 3A-3B, a front side of PCB 300 is shown in FIG. 3A, and the back side of PCB 300 is shown in FIG. 3B. Four Sockets 100 have been mounted onto PCB 300. Sockets 100 are designed to be soldered onto PCB 300. Holes are cut into PCB 300 for receiving Sockets 100. From the front side of PCB 300, Tail End 102 of each Socket 100 is put into the hole. The hole is larger in diameter than Tail End 102, but smaller in diameter than Enlarged Portion 104. Pressure is then applied to Socket 100 along its Central Axis 118, engaging Chamfer 106 against the inside edge of the hole, forcing Tail End 102 further into the hole until Enlarged Portion 104 is within the hole, and Seating Ring 108 seats against the front side of PCB 300. Thus, Socket 100 is held by pressure around the circumference of Enlarged Portion 104. After inserting each Socket 100 in this fashion, a solder ring is placed over Tail End 102 and seated against PCB 300. Then the solder is melted forming a very secure electrical connection. Do to the pressure connection and solder, Socket 100 can handle a lot of pressure in use. A standard wire soldering technique may be used instead of the solder ring. A soldering iron may be used to heat Socket 100 and a solder wire positioned appropriately to join Socket 100 to PCB 300. Once enough solder has been melted, the soldering iron and soldering wire are removed to allow the joint to cool down.

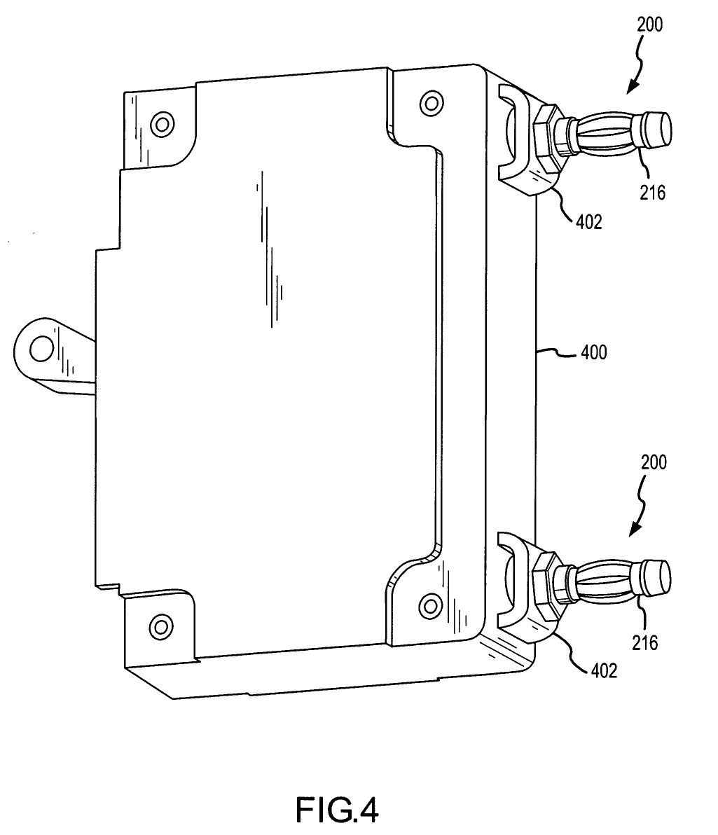

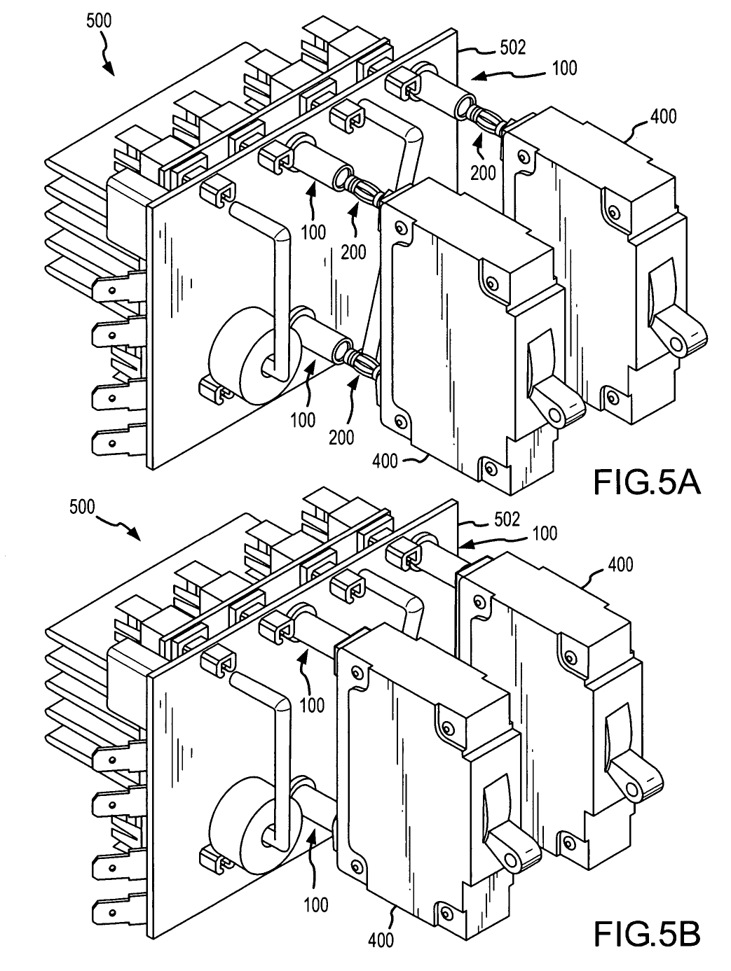

FIG. 4 shows a perspective view of an electrical device having pins for high current applications attached thereto, and FIGS. 5A-5B show two perspective views of a pair of the electrical devices of FIG. 4 being coupled to a printed circuit board having sockets for high current applications in an embodiment of the present invention. Referring now to FIG. 4 and FIGS. 5A-5B, one application having an embodiment of the high current pin and socket power connectors of the present invention involves theatrical lighting. A Dimming Module 500 connects into a rack that controls multiple lights, and all of the lights are controlled by a computer as to when to turn on, or turn off, or dim the individual lights. Dimming Module 500 has a solid state relay attached to PCB 502, which is similar to PCB 300 of FIG. 3. Four Sockets 100 are attached to PCB 502 as described above in relation to FIGS. 3A and 3B.

The electrical devices in this example are circuit breakers. Each Circuit Breaker 400 has two Pins 200. For this specific application, Pins 200 will be screwed down onto Terminals 402. Thus, Pins 200 in this application have internal threads within Bore 204.

A pair of Circuit Breakers 400 are attached to Dimming Module 500 by aligning Pins 200 on Circuit Breaker 400 with Sockets 100 on PCB 502, and then pushing Pins 200 within Sockets 100. Though only two Circuit Breakers 400 are shown in FIGS. 5A-5B, PCB 502 may carry up to four Circuit Breakers 400. For this specific application Sockets 100 and Pins 200 are made of brass to meet the electrical and mechanical specifications. The dimensions and thickness of the materials for Sockets 100 and Pins 200 handles the high current. The dimensions and thickness of the materials gives the tolerance needed for the high current.

In this application, PCB 502 has a thickness of 0.062″ (FR4), with an insertion hole of 0.238″ in diameter, and a solder pad of 0.400″. Sockets 100 and Pins 200 can be made of different metal alloys, depending upon the application. In this example, Band 216 is a male Torsional Louver type band, part no. 2-192042-8 available from AMP/TYCO.

Having described the present invention, it will be understood by those skilled in the art that many changes in construction and widely differing embodiments and applications of the invention will suggest themselves without departing from the scope of the present invention.

What is claimed is:

1. A power connector method for direct power connection between a printed circuit board and an electrical device, the power connector method comprising the steps of:
a) securing a pin to the electrical device;
b) attaching a socket to the printed circuit board; and
c) forcing said pin into said socket forming the power connection, wherein the power connection can carry a current of between ten to sixty amperes between the printed circuit board and the electrical device.

2. A method according to claim 1 further comprising the step of:
surrounding a stem of said pin with a male torsional louver type band before said forcing step, wherein said male torsional louver type band has a plurality of torsion members, wherein said plurality of torsion members are compressed when said stem having said male torsional louver type band is inserted in said socket, and further wherein said male torsional louver type band provides an electrical interface between said pin and said socket.

3. A method according to claim 1 wherein said securing step (a) further comprises the step of:
screwing said pin onto a threaded terminal of the electrical device, wherein said pin has a bore extending nearly through an entire length of a tail end distal from said stem, and said bore has an internal threads therein that engage with said threaded terminal.

4. A method according to claim 1 wherein said attaching step (b) further comprises the steps of:
inserting a tail end of said socket into a hole in a front side of the printed circuit board, wherein said hole has a diameter that is larger than a diameter of said tail end of said socket, but smaller than a diameter of an enlarged portion of said socket connected to said tail end;
forcing said enlarged portion of said socket into said hole until a seating ring connected to said enlarged portion seats against the printed circuit board, wherein said enlarged end is held by pressure in said hole; and
soldering said socket to the printed circuit board, forming a secure electrical connection between said socket and the printed circuit board.

5. A method according to claim 4 wherein said soldering step further comprises the steps of:
placing a solder ring over said tail end of said socket and seated against a back side of the printed circuit board; and
melting said solder ring, forming a secure electrical connection between said socket and the printed circuit board.

6. A method according to claim 4 wherein said forcing step of said attaching step (b) further comprises the step of:
forcing a chamfer located between said tail end and said enlarged portion of said socket through said hole, wherein said chamfer aids in forcing said enlarged portion of said socket into said hole in the printed circuit board.

7. A method according to claim 1 wherein said forcing step (c) further comprises the steps of:
forcing a chamfer located on a stem head end of a stem of said pin into a bore of said socket, wherein said chamfer aids in forcing said stem head end of said stem of said pin into said bore of said socket.

8. A power connector system for direct power connection between a printed circuit board and an electrical device, the power connector system comprising:
a pin secured to the electrical device; and
a socket attached to the printed circuit board;
wherein said socket receives said pin, and further wherein said pin and said socket can carry a current of between ten and sixty amperes between the printed circuit board and the electrical device.

9. The power connector system according to claim 8 wherein said pin further comprises:
a tail end that attaches to the electrical device;
a stem connected to said tail end; and
a band surrounding said stem, wherein said band provides an electrical interface between said pin and said socket.

10. The power connector system according to claim 9 wherein said band is a male torsional louver type band having a plurality of torsion members, wherein said plurality of torsion members are compressed when said stem is inserted in said socket and said plurality of torsion members engage an interior of a bore of said socket.

11. The power connector system according to claim 9 wherein said tail end of said pin further comprises:
a bore extending nearly through an entire length of said tail end, said bore having internal threads therein; and
a nut portion between said bore and said stem for assisting in screwing said pin onto a threaded terminal of the electrical device.

12. The power connector system according to claim 11 wherein said pin further comprises:
a stem head end distal from said tail end, said stem head end having a chamfer for assisting in inserting said pin into said socket.

13. The power connector system according to claim 9 wherein said socket further comprises:
a tail end having a first diameter;
an enlarged portion, connected to said tail end, said enlarged portion having a second diameter that is slightly larger than said first diameter; and
a seating ring, connected to said enlarged portion, having a third diameter that is larger than said second diameter;
wherein said tail end is inserted into a hole in a front side the printed circuit board, wherein said hole has a fourth diameter that is larger than said first diameter of said tail end, but smaller than said second diameter of said enlarged portion, and further wherein force is applied along a central axis of said socket to force said enlarged portion within said hole until said seating ring seats against the printed circuit board, and said enlarged end is held by pressure in said hole.

14. The power connector system according to claim 13 further comprising:
a solder ring placed over said tail end of said socket and seated against a back side of the printed circuit board, wherein said solder ring is melted and forms a secure electrical connection between the socket and the printed circuit board.

15. The power connector system according to claim 13 wherein said socket further comprises:
a chamfer between said tail end and said enlarged portion, wherein said chamfer aids in forcing said socket into said hole in the printed circuit board.

16. The power connector system according to claim 13 wherein said socket further comprises:
a shank connected to said seating ring, said shank having a bore extending nearly through its entire length;
wherein said bore receives said stem of said pin.

17. The power connector system according to claim 16 wherein said shank further comprises:
a head end distal from said tail end; and
an internal chamfer on said head end wherein said chamfer aids in receiving said stem of said pin.

18. The power connector system according to claim 8 wherein said electrical device is a circuit breaker, and further wherein two of said pins are attached to said circuit breaker and two of said sockets are attached to the printed circuit board, wherein said two of said pins are received into said two of said sockets.

19. A power connector system for direct power connection between a printed circuit board and an electrical device, the power connector system comprising:
a first pin secured to the electrical device;
a second pin secured to the electrical device;
a first socket attached to the printed circuit board; and
a second socket attached to the printed circuit board;
wherein said first socket receives said first pin and said second socket receives said second pin, and further wherein said first and second pins and said first and second sockets can carry a current of between ten and sixty amperes between the printed circuit board and the electrical device.

20. The power connector system according to claim 19 wherein each of said first and second pins further comprises:
a tail end that attaches to the electrical device;
a stem connected to said tail end; and
a band surrounding said stem, wherein said band provides an electrical interface between each of said first and second pins and each of said first and second sockets.

21. The power connector system according to claim 20 wherein said band is a male torsional louver type band having a plurality of torsion members, wherein said plurality of torsion members are compressed when each said stem is inserted in each of said first and second sockets and said plurality of torsion members engage an interior of a bore of each of said sockets.

22. The power connector system according to claim 20 wherein said tail end of said first and second pins further comprises:
a bore extending nearly through an entire length of said tail end, said bore having internal threads therein; and
a nut portion between said bore and said stem for assisting in screwing each of said first and second pins onto a first and second threaded terminal of the electrical device.

23. The power connector system according to claim 22 wherein each of said pins further comprises:
a stem head end distal from said tail end, said stem head end having a chamfer for assisting in inserting each of said first and second pins into each of said first and second sockets.

24. The power connector system according to claim 20 wherein each of said first and second sockets further comprises:
a tail end having a first diameter;
an enlarged portion, connected to said tail end, said enlarged portion having a second diameter that is slightly larger than said first diameter; and
a seating ring, connected to said enlarged portion, having a third diameter that is larger than said second diameter;
wherein said tail end is inserted into a hole in a front side the printed circuit board, wherein said hole has a fourth diameter that is larger than said first diameter of said tail end, but smaller than said second diameter of said enlarged portion, and further wherein force is applied along a central axis of said socket to force said enlarged portion within said hole until said seating ring seats against the printed circuit board, and said enlarged end is held by pressure in said hole.

25. The power connector system according to claim 24 further comprising:
a solder ring placed over said tail end of each of said first and second sockets and seated against a back side of the printed circuit board, wherein said solder rings are melted and form a secure electrical connection between each of said first and second sockets and the printed circuit board.

26. The power connector system according to claim 24 wherein each of said first and second sockets further comprises:
a chamfer between said tail end and said enlarged portion, wherein said chamfer aids in forcing each of said first and second sockets into said hole in the printed circuit board.

27. The power connector system according to claim 24 wherein each of said first and second sockets further comprises:
a shank connected to said seating ring, said shank having a bore extending nearly through its entire length;
wherein said bore receives said stem of each of said first and second pins.

28. The power connector system according to claim 27 wherein said shank further comprises:
a head end distal from said tail end; and
an internal chamfer on said head end wherein said chamfer aids in receiving said stems of each of said first and second pins.

29. The power connector system according to claim 19 wherein said electrical device is a circuit breaker, and the printed circuit board is a part of a dimming module for controlling theatrical lighting.
